(19) United States
(12) Patent Application Publication
(10) Pub. No.: US 2014/0355993 A1
(43) Pub. Date: Dec. 4, 2014

(54) ELECTRONIC DEVICE AND STORAGE MEDIUM WITH REMOTE CONTROL FUNCTION, AND REMOTE CONTROL METHOD

(71) Applicants: HONG HAI PRECISION INDUSTRY CO., LTD., New Taipei (TW); HONG FU JIN PRECISION INDUSTRY( ShenZhen) CO., LTD., Shenzhen (CN)

(72) Inventor: HAI-DONG TANG, Shenzhen (CN)

(21) Appl. No.: 13/920,091

(22) Filed: Jun. 18, 2013

(30) Foreign Application Priority Data
May 28, 2013 (CN) 201310203943X

(51) Int. Cl. G08C 23/04; G08C 19/00

(52) U.S. Cl. CPC G08C 23/04; G08C 19/00
USPC 398/106; 340/12.22

(57) ABSTRACT

An infrared control method is configured to remotely control a plurality of terminals via a remote control of an electronic device. The electronic device includes a first communication unit, a second communication unit, a storage unit storing an ID code of each terminal. The method includes the following steps. Obtaining a remote signal from the remote control received via the first communication unit and decoding the obtained remote signal. In addition, an ID code of a currently controlled terminal is obtained from the storage unit and then a control signal recognizable by the currently controlled terminal according to the decoded remote signal and the ID code of the currently controlled terminal is generated. Then, the generated control signal is sent to the currently controlled terminal via the second communication unit to direct the determined terminal to take an action.

### BACKGROUND

1. Technical Field

The present disclosure relates to electronic devices, and more particularly, to an electronic device and a storage medium capable of remotely controlling a number of terminals, and a remote control method adapted for the electronic device.

2. Description of Related Art

Different kinds of electronic devices may be controlled by different remote controls. For example, users may need to use a remote control of a set top box to control the set top box, and use a remote control of a television to control the television. It may be troublesome for users continue to switch remote controls for controlling different electronic devices.

Therefore, there is a need to provide a means to overcome the above-described shortcomings.

### BRIEF DESCRIPTION OF THE DRAWINGS

Many aspects of the present disclosure should be better understood with reference to the following drawings. The emphasis is placed upon clearly illustrating the principles of the present disclosure.

FIG. 1 is a block diagram of an electronic device with a remote control function, in accordance with an exemplary embodiment.

FIG. 2 is a flowchart of a remote control method, in accordance with an exemplary embodiment.

### DETAILED DESCRIPTION

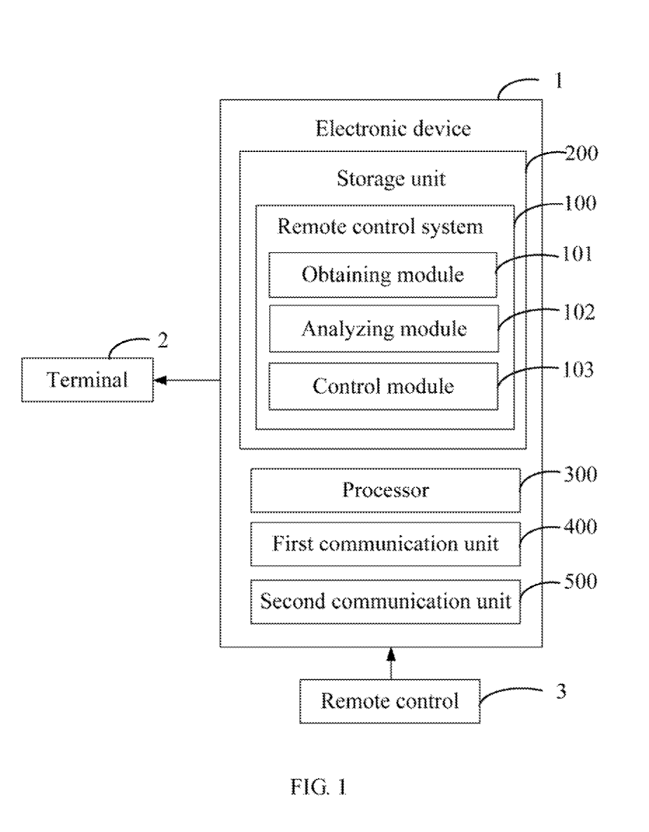

FIG. 1 is a block diagram of an electronic device 1 with a remote control function according to an exemplary embodiment. The electronic device 1 can remotely control a number of terminals 2 via a remote control 3 of the electronic device 1. In this embodiment, the electronic device 1 is a set top box, and the terminals 2 are different televisions. In this embodiment, which terminal 2 is currently controlled by the electronic device 1 can be manually set. For example, users can press different mechanical buttons of the remote control 3 to select the terminal 2 currently controlled by the electronic device 1 (hereinafter, currently controlled terminal 2). The electronic device 1 includes a storage unit 200, a processor 300, a first communication unit 400, and a second communication unit 500. The storage unit 200 stores an ID (identification, ID) code of each terminal 2. The storage unit 200 further stores a remote control system 100. The system 100 includes a variety of modules executed by the processor 300 to provide the functions of the system 100. A detailed description of the variety of modules will be described as follows.

In the embodiment, the system 100 includes an obtaining module 101, an analyzing module 102, and a control module 103.

The obtaining module 101 obtains a remote signal from the remote control 3 received by the electronic device 1 via the first communication unit 400. The first communication unit 400 may be a wireless access port or a wired access port. The communication between the electronic device 1 and the remote control 3 through the first communication unit 400 may be carried out via any suitable network protocol such as Bluetooth®.

The analyzing module 102 decodes the obtained remote signal. The analyzing module 102 obtains the ID code of the currently controlled terminal 2 from the storage unit 200, and generates a control signal recognizable by the currently controlled terminal 2 according to the decoded remote signal and the ID code of the currently controlled terminal 2.

The control module 103 sends the control signal to the currently controlled terminal 2 via the second communication unit 500 to direct the currently controlled terminal 2 to take an action, for example, turn down the volume.

In the embodiment, the control signal generated by the analyzing module 102 is an infrared control signal, and the analyzing module 102 embeds the ID code of the currently controlled terminal 2 into the front of the decoded remote signal to obtain the infrared control signal. The second communication unit 500 is an infrared receiver, and the infrared control signal is sent to the currently controlled terminal 2 via the infrared receiver.

In the embodiment, the analyzing module 102 further analyzes the function of the remote signal. If the remote signal can be employed to control the electronic device 1 and the terminal 2, the control module 103 is further configured to control the electronic device 1 to take an action corresponding to the remote signal. For example, if the analyzing module 102 determines that the function of the remote signal is to turn off a device, the control module 103 transmits the control signal to turn off the terminal 2, and then turns off the electronic device 1.

With such configuration, the user can use the remote control 3 of the electronic device 1 to control a number of terminals 2.

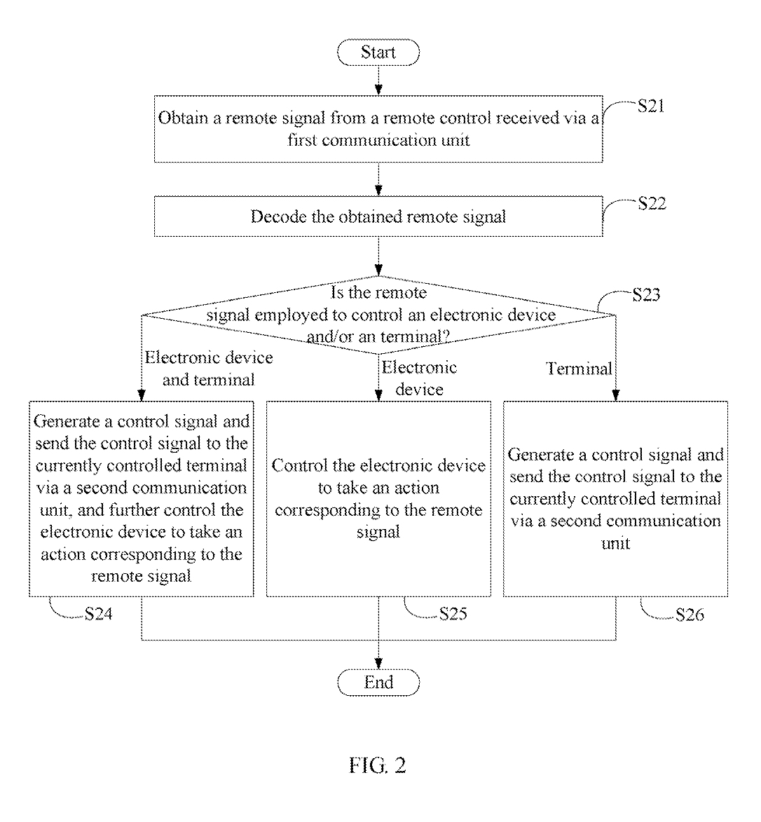

FIG. 2 is a flowchart of a remote control method, in accordance with an exemplary embodiment.

In step S21, the obtaining module 101 obtains a remote signal from the remote control 3 received by the electronic device 1 via the first communication unit 400.

In step S22, the analyzing module 102 decodes the obtained remote signal.

In step S23, the analyzing module 102 analyzes the function of the remote signal and determines whether the remote signal is employed to control the electronic device 1 and/or the terminal 2. If the remote signal can be employed to control the electronic device 1 and the terminal 2, the procedure goes to step S24. If the remote signal is employed to control the electronic device 1, the procedure goes to step S25. If the remote signal is employed to control the terminal 2, the procedure goes to step S26.

In step S24, the control module 103 generates a control signal recognizable by the currently controlled terminal 2 and sends the control signal to the currently controlled terminal 2 via the second communication unit 500 to direct the currently controlled terminal 2 to take an actions, and further controls the electronic device 1 to take an action corresponding to the remote signal. More specifically, the analyzing module 102 obtains the ID code of the currently controlled terminal 2 from the storage unit 200, and generates the control signal recognizable by the currently controlled terminal 2 according to the decoded remote signal and the ID code of the currently controlled terminal 2.

In step S25, the control module 103 controls the electronic device 1 to take an action corresponding to the remote signal.

In step S26, the control module 103 generates a control signal recognizable by the currently controlled terminal 2 and sends the control signal to the currently controlled terminal 2 via the second communication unit 500 to direct the currently controlled terminal 2 to take an action.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments.

What is claimed is:

1. An electronic device configured to remotely control a plurality of terminals via a remote control of the electronic device, the electronic device comprising:
a first communication unit;
a second communication unit;
a storage unit storing an ID code of each terminal, and a plurality of modules; and
a processor to execute the plurality of modules,
wherein the plurality of modules comprises:
an obtaining module to obtain a remote signal from the remote control received via the first communication unit;
an analyzing module to decode the obtained remote signal, obtain an ID code of a currently controlled one of the terminals from the storage unit, and generate a control signal recognizable by the currently controlled terminal according to the decoded remote signal and the ID code of the currently controlled terminal; and
a control module to send the generated control signal to the currently controlled terminal via the second communication unit to direct the determined terminal to take an action.

2. The electronic device of claim 1, wherein the first communication unit is a wireless access port or a wired access port.

3. The electronic device of claim 1, wherein the control signal generated by the analyzing module is an infrared control signal, and the analyzing module is configured to embed the ID code of the currently controlled terminal into a front of the decoded remote signal to obtain the infrared control signal.

4. The electronic device of claim 3, wherein the second communication unit is an infrared receiver, and the infrared control signal is sent to the currently controlled terminal via the infrared receiver.

5. The electronic device of claim 1, wherein the analyzing module is further configured to analyze a function of the remote signal, if the remote signal is employed to control the electronic device and the terminal, the control module is further configured to control the electronic device to take an action corresponding to the remote signal.

6. The electronic device of claim 1, wherein the currently controlled terminal is manually select from the plurality of terminals via the remote control.

7. An infrared control method applied in an electronic device with a remote control function, the electronic device configured to remotely control a plurality of terminals via a remote control of the electronic device, the electronic device comprising a first communication unit, a second communication unit, a storage unit storing an ID code of each terminal, the method comprising:
obtaining a remote signal from the remote control received via the first communication unit;
decoding the obtained remote signal;
obtaining an ID code of a currently controlled one of the terminals from the storage unit;
generating a control signal recognizable by the currently controlled terminal according to the decoded remote signal and the ID code of the currently controlled terminal; and
sending the generated control signal to the currently controlled terminal via the second communication unit to direct the determined terminal to take an action.

8. The infrared control method of claim 7, wherein the control signal is an infrared control signal generated by embedding the ID code of the currently controlled terminal into a front of the decoded remote signal.

9. The infrared control method of claim 7, wherein the step decoding the obtained remote signal further comprises:
analyzing a function of the remote signal;
controlling the electronic device to take an action corresponding to the remote signal if the remote signal is employed to control the electronic device and the terminal.

10. A storage medium storing a plurality of modules, the plurality of modules comprising instructions executable by a processor of an electronic device to perform a remote control method, the electronic device configured to remotely control a plurality of terminals via a remote control of the electronic device, the electronic device comprising a first communication unit, a second communication unit, a storage unit storing an ID code of each terminal, the method comprising:
obtaining a remote signal from the remote control received via the first communication unit;
decoding the obtained remote signal;
obtaining an ID code of a currently controlled one of the terminals from the storage unit;
generating a control signal recognizable by the currently controlled terminal according to the decoded remote signal and the ID code of the currently controlled terminal; and
sending the generated control signal to the currently controlled terminal via the second communication unit to direct the determined terminal to take an action.

11. The storage medium of claim 10, wherein the control signal is an infrared control signal generated by embedding the ID code of the currently controlled terminal into a front of the decoded remote signal.

12. The storage medium of claim 10, wherein the step decoding the obtained remote signal further comprises:
analyzing a function of the remote signal;
controlling the electronic device to take an action corresponding to the remote signal if the remote signal is employed to control the electronic device and the terminal.
